(19) United States
(12) Patent Application Publication
(10) Pub. No.: US 2025/0138533 A1
(43) Pub. Date: May 1, 2025

(54) DYNAMIC INDOOR NAVIGATION

(71) Applicant: INTERNATIONAL BUSINESS MACHINES CORPORATION, ARMONK, NY (US)

(72) Inventors: Rachana Vishwanathula, Hyderabad (IN); Rahul Reddy Ravipally, Bengaluru (IN); Srikanth Manne, Bengaluru (IN); Shanmugaraja Selvam, Ariyalur (IN); Preethi C Mohan, Bangalore (IN)

(21) Appl. No.: 18/495,843

(22) Filed: Oct. 27, 2023

(51) Int. Cl. G05D 1/02

(52) U.S. Cl. CPC G05D 1/0214

(57) ABSTRACT

A method, computer system, and a computer program product for dynamic indoor navigation is provided. The present invention may include receiving a set of sensor data from at least one distance measuring sensor located in an enclosed environment. The present invention may include generating a baseline map of the enclosed environment based on the received set of sensor data. The present invention may include detecting at least one object in the enclosed environment based on the received set of sensor data. The present invention may include generating an obstacle map of the enclosed environment by plotting the detected at least one object in the generated baseline map of the enclosed environment. The present invention may include determining a movement path through the enclosed environment that avoids the detected at least one object in the generated obstacle map.

### BACKGROUND

The present invention relates generally to the field of computing, and more particularly to autonomous navigation.

Navigational guidance is critical to the movement of autonomous robots through an environment. Navigation in outdoor environments may be guided by the Global Positioning System (GPS). However, navigation systems that employ GPS are typically unreliable for indoor navigation. Existing approaches for indoor navigation have expensive overhead costs and functional limitations, such as when the environment includes dynamically moving obstacles.

### SUMMARY

Embodiments of the present invention disclose a method, computer system, and a computer program product for dynamic indoor navigation. The present invention may include receiving a set of sensor data from at least one distance measuring sensor located in an enclosed environment. The present invention may include generating a baseline map of the enclosed environment based on the received set of sensor data. The present invention may include detecting at least one object in the enclosed environment based on the received set of sensor data. The present invention may include generating an obstacle map of the enclosed environment by plotting the detected at least one object in the generated baseline map of the enclosed environment. The present invention may include determining a movement path through the enclosed environment that avoids the detected at least one object in the generated obstacle map.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of an indoor navigation system according to at least one embodiment;

FIG. 3 is an operational flowchart illustrating a process for indoor navigation according to at least one embodiment;

FIG. 4 is a schematic block diagram illustrating an example of baseline map generation according to at least one embodiment;

FIG. 5 is a schematic block diagram illustrating an example of obstacle map generation according to at least one embodiment; and

FIG. 6 is a schematic block diagram illustrating an example of movement path planning according to at least one embodiment.

### DETAILED DESCRIPTION

The following described exemplary embodiments provide a system, method, and computer program product for dynamic indoor navigation. As such, the present embodiment has the capacity to improve the technical field of autonomous navigation by using a stationary distance measuring sensor located in an enclosed environment to map the boundaries and obstacles in the enclosed environment and generate an obstacle-avoidance movement path for a navigation device that is traversing through the enclosed environment. More specifically, an indoor navigation program may receive a set of sensor data from at least one distance measuring sensor located in an enclosed environment. The indoor navigation program may generate a baseline map of the enclosed environment based on the received set of sensor data, where the generated baseline map may include one or more boundaries that define the enclosed environment. The indoor navigation program may detect at least one object in the enclosed environment based on the received set of sensor data. The indoor navigation program may generate an obstacle map of the enclosed environment by plotting the detected at least one object in the generated baseline map of the enclosed environment. Then, the indoor navigation program may determine a movement path through the enclosed environment that avoids the detected at least one object in the generated obstacle map. Thereafter, the indoor navigation program may transmit the determined movement path to a navigation device for traversing through the enclosed environment.

As described previously, navigational guidance is critical to the movement of autonomous robots through an environment. While navigation in outdoor environments may be guided by GPS, navigation systems that employ GPS are typically unreliable for indoor navigation. Existing approaches for indoor navigation may utilize Bluetooth beacons, Wi-Fi beacons and/or cameras located throughout the enclosed environment for localizing the navigating device, as well as specialized sensors and cameras onboard the navigating device for mapping the enclosed environment and obstacle avoidance. However, in addition to expensive overhead costs, existing approaches have functional limitations related to the accuracy in localizing the navigating device and obstacle avoidance of dynamically moving objects.

Therefore, it may be advantageous to, among other things, provide a way to automate real-time object detection of dynamic obstacles for indoor navigation using fewer computing resources. It may be advantageous to use one or more stationary distance measuring sensors located in an enclosed environment to capture the distance from the sensors to the objects/boundaries around the sensors to automatically generate a layout of the obstacles on the floor and air space inside the environment. It may also be advantageous to combine the sensor data from multiple distance measuring sensors to identify and plot the exact shape and size of the objects in the environment. It may further be advantageous to use the sensor data to generate a real-time movement path for a navigation device traversing the enclosed environment.

According to embodiments of the present disclosure, one or more 360-degree distance measuring sensors may be installed on a wall, ceiling, floor, or any other surface in an enclosed environment. The distance measuring sensors may initially capture the measurements associated with the boundaries of the enclosed environment (e.g., distance from ceiling to the floor, distance between the walls and edges). In one embodiment, the distance measuring sensors may transmit some form of energy (e.g., sound, light, magnetism) and record a first set of measurements of the reflected energy in an empty space of the enclosed environment as a baseline. If the enclosed environment includes objects, the distance measuring sensors may record a second set of measurements of the transmitted energy reflecting off of the objects. In one embodiment, the second set of measurements may be within the ranges of the first set of measurements identified in the empty space and may be used to map the location/coordinates of the objects on a grid/map. The first set of measurements and the second set of measurements may be used to plot an obstacle-free, optimal path on a map which can be fed into navigation device (e.g., drone, robot, another mobile device). The present disclosure of the indoor navigation program may be implemented into an application which provides data in real-time to be used by the navigation device or a visually impaired user to navigate inside the enclosed environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

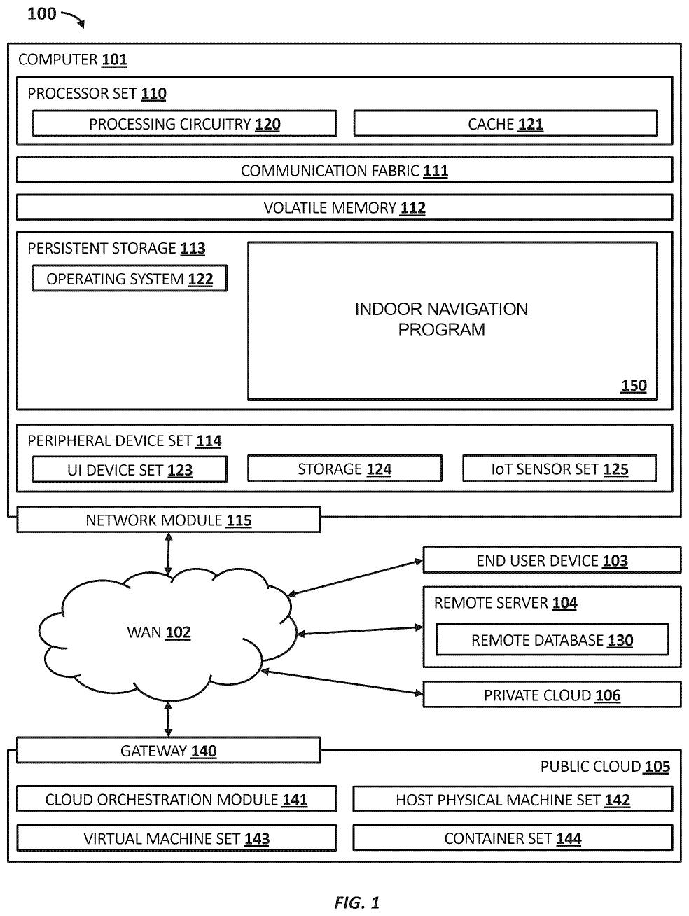

Referring to FIG. 1, a computing environment 100 according to at least one embodiment is depicted. Computing environment 100 contains an example of an environment for the execution of at least some of the computer code involved in performing the inventive methods, such as indoor navigation program 150. In addition to indoor navigation program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and indoor navigation program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, indoor navigation program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The indoor navigation program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

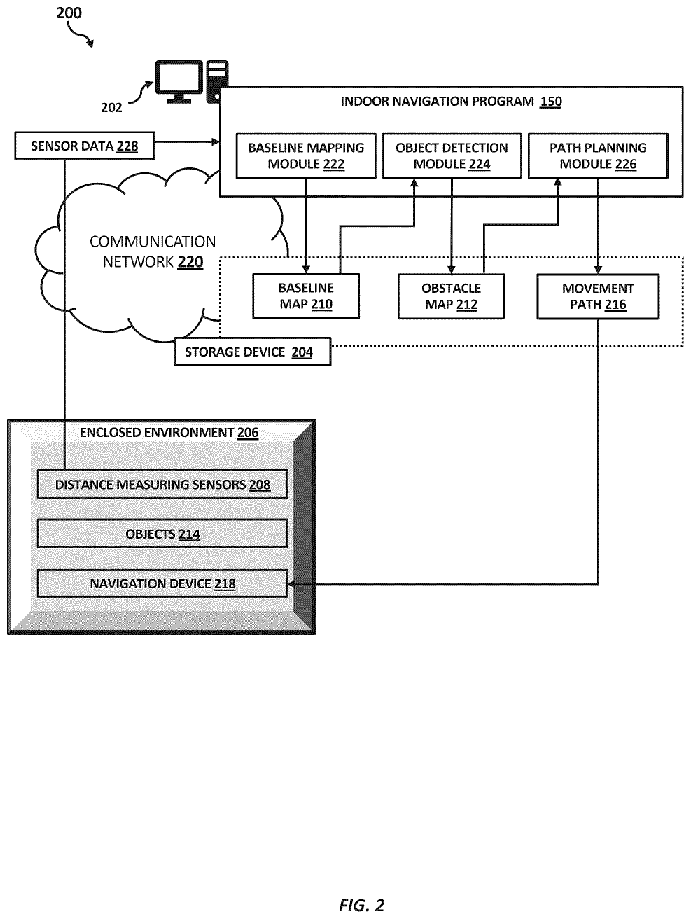

According to the present embodiment, a user interacting with any combination of computer 101, EUD 103, remote server 104, public cloud 105, and private cloud 106 may implement the indoor navigation program 150 to provide automated real-time navigational guidance to a device that is moving through an enclosed environment where GPS guidance is unavailable. Embodiments of the present disclosure are explained in more detail below with respect to FIGS. 2 to 6.

Referring now to FIG. 2, a schematic block diagram of an indoor navigation system 200 according to at least one embodiment is depicted. According to one embodiment, the indoor navigation system 200 may be implemented in the computing environment 100 described with reference to FIG. 1 and include a specialized computer system 202 having a tangible storage device 204 and a processor that is enabled to run the indoor navigation program 150.

As such, various embodiments of the computer system 202 may include one or more components (e.g., computer 101; end user device (EUD) 103; WAN 102) of the computer environment 100. In one embodiment, the computer system 202 may include one or more computers (e.g., computer 101) which may take the form of a desktop computer, laptop computer, tablet computer, smart phone, smart watch or other wearable computer, mainframe computer, quantum computer, unmanned vehicles, automated robots, or any other form of computer or mobile device now known or to be developed in the future that is capable of running a program, accessing a network, and/or querying a database. In at least one embodiment, aspects of the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

Generally, the computer system 202 may be enabled by the indoor navigation program 150 to perform indoor navigation in an enclosed environment 206. As will be further detailed below, the indoor navigation program 150 may implement one or more distance measuring sensors 208 installed in the enclosed environment 206 to generate a baseline map 210 of the enclosed environment 206, an obstacle map 212 layered on top of the baseline map 210 that plots one or more objects 214 located in the enclosed environment 206, and a movement path 216 that enables unobstructed movement of a navigation device 218 through the enclosed environment 206.

According to one embodiment, the indoor navigation program 150 may be practiced in distributed cloud computing environments where tasks may be performed by local and/or remote processing devices which may be linked through a communication network 220. In at least one embodiment, the indoor navigation program 150 may be executed on a single computing device. The communication network 220 may include various types of communication networks, such as the wide area network (WAN) 102, described with reference to FIG. 1. In some embodiments, the WAN may be replaced and/or supplemented by a local area network (LAN), a telecommunication network (e.g., 3G, 4G, 5G), a wireless network, a public switched network and/or a satellite network. In one embodiment, the communication network 220 may enable data to be transferred between the distance measuring sensors 208, computer system 202 running the indoor navigation program 150, storage device 204, and navigation device 218 using short-range wireless technologies, such as, for example, Wi-Fi and/or Bluetooth® (Bluetooth and all Bluetooth-based trademarks and logos are trademarks or registered trademarks of Bluetooth SIG, Inc. and/or its affiliates).

According to one embodiment, the indoor navigation program 150 may include a single computer program or multiple program modules or sets of instructions being executed by the processor of the computer system 202. In one embodiment, the indoor navigation program 150 may include routines, objects, components, units, logic, data structures, and actions that may perform particular tasks or implement particular abstract data types. In at least one embodiment, the indoor navigation program 150 may include a baseline mapping module 222 for generating the baseline map 210 of the enclosed environment 206, an object detection module 224 for identifying objects 214 in the enclosed environment 206 and layering the obstacle map 212 including the identified objects 214 on top of the baseline map 210, and a path planning module 226 for building the movement path 216 for the navigation device 218 between a source and a destination in the enclosed environment 206.

According to one embodiment, the enclosed environment 206 may include any space where GPS and other satellite-based mapping, tracking, and navigation is unavailable/unreliable due to signal loss caused by environmental boundaries (e.g., roofs, ceiling, walls, and other objects). Examples of enclosed environment 206 may include, rooms, buildings, airports, warehouses, parking garages, underground tunnels, and any other confined locations.

The present disclosure may provide a solution to the above deficiencies of satellite-based technologies by enabling mapping, tracking, and navigation within the enclosed environment 206 using one or more distance measuring sensors 208 located therein. The distance measuring sensors 208 may be placed at logical points (e.g., ceiling, floor, walls) in the enclosed environment 206 where the distance measuring sensors 208 can provide maximum signal coverage of the area. The distance measuring sensors 208 may include various types of 360-degree distance sensors, such as, light sensors, sound sensors, and/or electromagnetic sensors. Some examples of distance measuring sensors 208 may include, ultrasonic distance sensors, infrared (IR) distance sensors, light detection and ranging (LiDAR) sensors, vertical cavity surface emitting laser (VCSEL) sensors, radio detection and ranging (RADAR) sensors, sound navigation and ranging (SONAR) sensors, tunnel magneto-resistance effect (TMR) sensors, ultraviolet sensors, and radio frequency identification (RFID) sensors. Distance measuring sensors 208 may measure the distance from the sensors to a target by outputting a signal (e.g., some form of energy) and converting the change in the return signal that is reflected back from the target into a distance measure.

According to one embodiment, the enclosed environment 206 may initially be an unmapped space. That is, the indoor navigation program 150 may not have information regarding the interior structure and dimensions of the various bounding elements (e.g., ceiling, walls, floors) of the enclosed environment 206. In order to determine what the enclosed environment 206 looks like and generate the baseline map 210, the indoor navigation program 150 may implement the distance measuring sensors 208 to capture a first set of measurements indicating first respective distances between each distance measuring sensor 208 and the surfaces around it.

In one embodiment, the enclosed environment 206 may initially be an empty enclosed area (e.g., a room with no objects within the boundaries of the room). As such, the surfaces around the distance measuring sensors 208 may include the boundaries of the enclosed environment 206. In such embodiments, the first set of measurements recorded by the distance measuring sensors 208 may be associated with the boundaries of the enclosed environment 206 (e.g., distance from ceiling to the floor, distance between the walls and edges). However, in at least one embodiment, the enclosed environment 206 may already include the objects 214 prior the indoor navigation program 150 generating the baseline map 210. In such embodiments, the indoor navigation program 150 may instruct the distance measuring sensors 208 to record the first set of measurements as the distance from the distance measuring sensors 208 to the surfaces that are furthest from the distance measuring sensors 208 in each direction. By recording the distances to the furthest surfaces relative to each distance measuring sensor 208, the distance measuring sensors 208 may record the first set of measurements associated with the boundaries of the enclosed environment 206, even if the enclosed environment 206 includes the objects 214.

In one embodiment, the first set of measurements generated by the distance measuring sensors 208 may be included in sensor data 228 and transmitted to the indoor navigation program 150. In one embodiment, if the enclosed environment 206 includes multiple distance measuring sensors 208, the first set of measurements from each distance measuring sensor 208 may be collated and included in the sensor data 228.

According to one embodiment, the indoor navigation program 150 may receive the sensor data 228 from the distance measuring sensors 208 and implement the baseline mapping module 222 to generate the baseline map 210 as a reference map of the enclosed environment 206. In one embodiment, the baseline map 210 may include a two-dimensional (2D) or three-dimensional (3D) map of the boundaries of the enclosed environment 206. In one embodiment, the baseline mapping module 222 may apply a grid on the baseline map 210 and convert the first set of measurements in the sensor data 228 into cartesian coordinates. By using the grid on the baseline map 210, the baseline mapping module 222 may uniquely specify the locations of the boundaries of the enclosed environment 206 and the areas enclosed by the boundaries in the enclosed environment 206. In one embodiment, the grid spacing may be a preset feature of the indoor navigation program 150. However, in at least one embodiment, the grid spacing may also be configurable by a user interacting with the indoor navigation program 150. In one embodiment, the indoor navigation program 150 may store the baseline map 210 in the storage device 204 for referencing and further processing by the object detection module 224 and the path planning module 226. In one embodiment, the baseline mapping module 222 may generate and store a visualization of the baseline map 210 which may be accessed and viewed by the user on a display device.

According to one embodiment, the distance measuring sensors 208 may also be used to detect if the enclosed environment 206 includes objects 214 within its boundaries. In one embodiment, the indoor navigation program 150 may instruct the distance measuring sensors 208 to measure the distances from the distance measuring sensors 208 to the objects 214 based on the sensor transmitted energy reflecting off of the surfaces of the objects 214. The distance measuring sensors 208 may record second respective distances to the objects around it as a second set of measurements. According to one embodiment, if the enclosed environment 206 includes any objects 214 within its boundaries, the distance measuring sensors 208 may capture its presence, structure, shape, and dimensions in the recorded second set of measurements. In one embodiment, the second set of measurements from multiple distance measuring sensors 208 may be collated (e.g., merged) to provide the exact shape and dimensions of the objects 214 in the enclosed environment 206. The second set of measurements may be included in the sensor data 228 and transmitted to the indoor navigation program 150.

According to one embodiment, the indoor navigation program 150 may implement the object detection module 224 to compare the first set of measurements from the baseline map 210 (stored in storage device 204) and the second set of measurements to determine the exact position, structure, and size of the objects 214 in the enclosed environment 206. In one embodiment, the object detection module 224 may plot the second set of measurements on the baseline map 210 to generate the obstacle map 212, where the obstacle map 212 includes the objects 214 located in the enclosed environment 206.

According to one embodiment, the second set of measurements from the distance measuring sensors 208 may include real-time measurements that may capture any movements of the objects 214 in the enclosed environment 206. In one embodiment, the sensor data 228 may include a real-time stream of data that may be continuously or periodically transmitted from the distance measuring sensors 208 to the indoor navigation program 150. In one embodiment, the object detection module 224 may use the real-time second set of measurements to dynamically update the obstacle map 212. Thus, the obstacle map 212 may include a dynamic map that captures any movements of the objects 214 in the enclosed environment 206. In one embodiment, the object detection module 224 may generate and store a visualization of the obstacle map 212 which may be accessed and viewed by the user on a display device.

According to one embodiment, the indoor navigation program 150 may implement the path planning module 226 to build the movement path 216 through the enclosed environment 206. In one embodiment, the path planning module 226 may receive a source (e.g., starting point) and a destination for the navigation device 218 trying to move through the enclosed environment 206. The path planning module 226 may receive the obstacle map 212 and apply a shortest path algorithm to create an obstacle free movement path 216 from the source to the destination. In one embodiment, the movement path 216 may be stored in the storage device 204 and transmitted to a navigation system of the navigation device 218. Examples of the navigation device 218 may include unmanned vehicles, automated robots, and a mobile device used for navigation (e.g., for visually impaired users). In one embodiment, the movement path 216 may also be provided to the navigation device 218 to enable exploration of the enclosed environment 206, rather than moving from the source to the destination. The movement path 216 may be updated by the path planning module 226 in real-time, based on any changes in the obstacle map 212 (e.g., movement of objects 214 in the enclosed environment 206).

According to one embodiment, the movement path 216 may enable the navigation device 218 to move autonomously through the enclosed environment 206 without additional guidance from any onboard sensors of the navigation device 218. Thus, even if the navigation device 218 did not include an onboard camera or other onboard sensors (e.g., obstacle detection sensors), the indoor navigation program 150 may enable the navigation device 218 to move autonomously through the enclosed environment 206 based on the real-time movement path 216 provided by the path planning module 226.

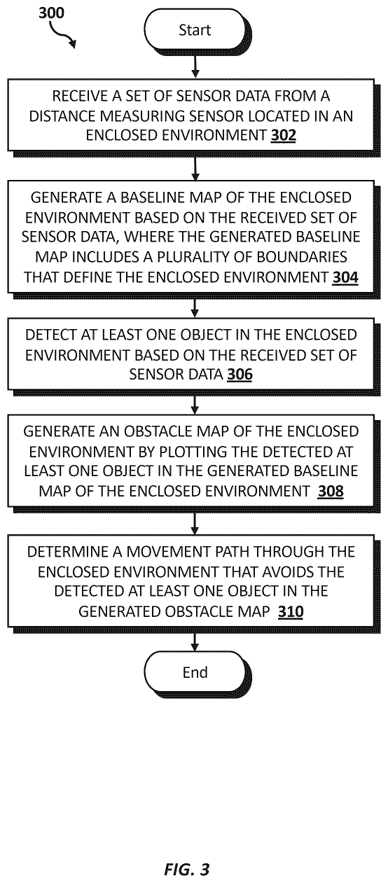

Referring now to FIG. 3, an operational flowchart illustrating an exemplary process 300 used by the indoor navigation program 150 according to at least one embodiment is depicted. FIG. 3 provides a description of process 300 with reference to the indoor navigation system 200 (FIG. 2).

At 302, a set of sensor data is received from a distance measuring sensor located in an enclosed environment. According to one embodiment, the enclosed environment may be equipped with one or more distance measuring sensors in strategic locations where the distance measuring sensors may provide maximum sensing coverage. The enclosed environment and any objects therein may initially be unmapped and unknown to the indoor navigation program 150. In order to learn this information, the indoor navigation program 150 may instruct the distance measuring sensors to capture a first set of measurements associated with the distances to the boundaries of the enclosed environment (e.g., distance from ceiling to the floor, distance between the walls and edges) and a second set of measurements associated with the distances to any objects within the boundaries of the enclosed environment, as described previously with reference to FIG. 2. The first and second set of measurements from the distance measuring sensors may be included in the set of sensor data and transmitted to the indoor navigation program for further processing. The set of sensor data may be transmitted to the indoor navigation program in real-time and dynamically updated to include any changes to the boundaries of the enclosed environment or the objects located therein.

Then at 304, a baseline map of the enclosed environment is generated to include one or more boundaries that define the enclosed environment. It is contemplated that the enclosed environment may include an area that is confined using bounding elements such as, for example, a floor, one or more walls, and a ceiling. The structure, shape, and dimensions of these bounding elements may be captured by the distance measuring sensors in the first set of measurements and received by the indoor navigation program in the set of sensor data. According to one embodiment, the indoor navigation program may use the set of sensor data from the distance measuring sensors and generate a baseline map of the enclosed environment. In one embodiment, the baseline map may be generated as a 2D reference map or a 3D reference map of the boundaries of the enclosed environment. In one embodiment, the indoor navigation program may apply a grid on the baseline map and convert the first set of measurements in the set of sensor data into cartesian coordinates for uniquely identifying the boundaries of the enclosed environment and any point within the boundaries of the enclosed environment.

Then at 306, at least one object is detected in the enclosed environment based on the received set of sensor data. According to one embodiment, if the enclosed environment includes any objects within its boundaries, the distance measuring sensors may capture its presence, structure, shape, and dimensions in the recorded second set of measurements. In one embodiment, the distance measuring sensors may continuously or periodically update its measurements such that nny movement of the objects, addition/substruction of the objects may also be determined by the changes to the second set of measurements. The indoor navigation program may determine this information based on the set of sensor data received from the distance measuring sensors in real-time.

Then at 308, an obstacle map of the enclosed environment is generated by plotting the detected at least one object in the generated baseline map of the enclosed environment. According to one embodiment, the indoor navigation program may compare the first set of measurements from the baseline map and the second set of measurements to determine the exact position, structure, and size of the objects in the enclosed environment. In one embodiment, the indoor navigation program may plot the second set of measurements on the baseline map to generate an obstacle map, where the obstacle map may include the objects located in the enclosed environment. In one embodiment, the indoor navigation program may use the real-time second set of measurements to dynamically update the obstacle map. Thus, the obstacle map may include a dynamic map that captures any movements of the objects in the enclosed environment.

Thereafter at 310, a movement path through the enclosed environment is determined, where the movement path avoids the detected at least one object in the generated obstacle map. According to one embodiment, the indoor navigation program may generate a movement path for a navigation device that is trying to move through or explore the enclosed environment. in one embodiment, the indoor navigation program may tailor the movement path for each navigation device based on one or more characteristics (e.g., specification) of the navigation device (e.g., size, shape, ground-based movement, aerial movement). In one embodiment, the indoor navigation program may receive the obstacle map and apply a shortest path algorithm to create an obstacle free movement path for the navigation device from a source (e.g., start point) to a destination (e.g., end point). The movement path may be fed to the navigation device to enable the navigation device to move autonomously through the enclosed environment. In one embodiment, the movement path may also be provided to the navigation device to enable exploration of the enclosed environment, rather than moving from the source to the destination. In one embodiment, the movement path may be updated by the indoor navigation program in real-time, based on any changes in the obstacle map (e.g., movement of objects in the enclosed environment).

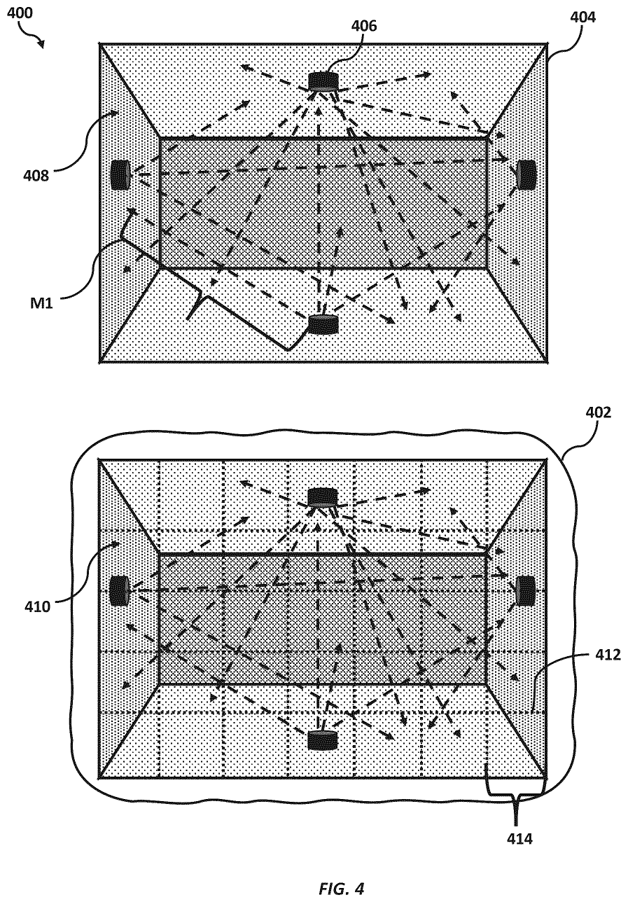

Referring now to FIG. 4, a schematic block diagram illustrating an example 400 of generating a baseline map using the indoor navigation program 150 according to at least one embodiment is depicted. FIG. 4 provides a description of example 400 with reference to the indoor navigation system 200 (FIG. 2).

According to one embodiment, the indoor navigation program 150 may be used to generate a baseline map 402 (an example of baseline map 210 in FIG. 2) of an enclosed environment 404 (an example of enclosed environment 206 in FIG. 2). One or more distance measuring sensors 406 (an example of distance measuring sensors 208 in FIG. 2) may be placed at logical points in the enclosed environment 404 where the distance measuring sensors 406 can provide maximum signal coverage of the area. In example 400, four distance measuring sensors 406 are installed in the enclosed environment 404 (e.g., ceiling, floor, walls).

In order to determine what the enclosed environment 404 looks like and generate the baseline map 402, the indoor navigation program 150 may implement the distance measuring sensors 406 to capture a first set of measurements M1 indicating the distances between each distance measuring sensor 406 and the surfaces around it. The enclosed environment 404 may initially be an empty enclosed area such that the surfaces around the distance measuring sensors 406 may include one or more boundaries 408 (e.g., ceiling, floor, walls) of the enclosed environment 404. In such embodiments, the first set of measurements M1 recorded by the distance measuring sensors 406 may be associated with the boundaries 408 of the enclosed environment 404 (e.g., distance from ceiling to the floor, distance between the walls and edges).

In one embodiment, the first set of measurements M1 generated by the distance measuring sensors 406 may be included in sensor data 228 (FIG. 2) and transmitted to the indoor navigation program 150. In example 400, the first set of measurements M1 from each of the four distance measuring sensors 406 may be merged and included in the sensor data 228.

According to one embodiment, the indoor navigation program 150 may receive the sensor data 228 from the distance measuring sensors 406 and generate the baseline map 402 as a reference map of the enclosed environment 404. In one embodiment, the baseline map 402 may include a two-dimensional (2D) or three-dimensional (3D) map of the enclosed environment 404. In one embodiment, the baseline map 402 may include mapped boundaries 410 that correspond to the physical boundaries 408 of the enclosed environment 404.

In one embodiment, the indoor navigation program 150 may apply a grid 412 on the baseline map 402 and convert the first set of measurements M1 in the sensor data 228 into cartesian coordinates provided by the grid 412. By using the grid 412 on the baseline map 402, the indoor navigation program 150 may uniquely specify the locations of the mapped boundaries 410 in the baseline map 402 and the areas enclosed by the mapped boundaries 410 in the baseline map 402. In one embodiment, a grid spacing 414 of the grid 412 may be a preset feature of the indoor navigation program 150. However, in at least one embodiment, the grid spacing 414 may also be configurable by a user interacting with the indoor navigation program 150. In one embodiment, the indoor navigation program 150 may generate and store a visualization of the baseline map 402 which may be accessed and viewed by a user on a display device.

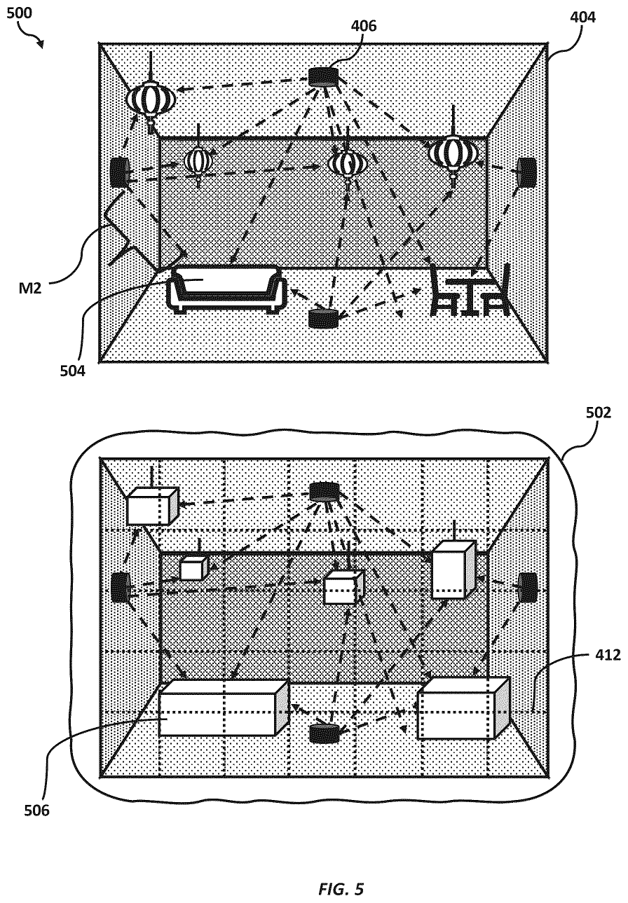

Referring now to FIG. 5, a schematic block diagram illustrating an example 500 of generating an obstacle map using the indoor navigation program 150 according to at least one embodiment is depicted. FIG. 5 provides a description of example 500 with reference to the indoor navigation system 200 (FIG. 2) and example 400 of generating the baseline map 402 (FIG. 4).

According to one embodiment, the indoor navigation program 150 may be used to generate an obstacle map 502 (an example of obstacle map 212 in FIG. 2) of the enclosed environment 404 (an example of enclosed environment 206 in FIG. 2).

According to one embodiment, the indoor navigation program 150 may implement the distance measuring sensors 406 to detect if the enclosed environment 404 includes any objects 504 (an example of object 214 in FIG. 2). The indoor navigation program 150 may instruct the distance measuring sensors 406 to measure the distances from the distance measuring sensors 406 to the objects 504 based on the sensor transmitted energy reflecting off of the surfaces of the objects 504. The distance measuring sensors 406 may record the distances to the objects 504 around it as a second set of measurements M2. In one embodiment, the second set of measurements M2 from the four distance measuring sensors 406 may be merged to provide the exact shape and dimensions of the objects 504 in the enclosed environment 404. The second set of measurements M2 may be included in the sensor data 228 (FIG. 2) and transmitted to the indoor navigation program 150.

According to one embodiment, the indoor navigation program 150 may compare the first set of measurements M1 used to generate the baseline map 402 and the second set of measurements M2 to determine the exact position, structure, and size of the objects 504 in the enclosed environment 404. In one embodiment, the indoor navigation program 150 may plot the second set of measurements M2 on the baseline map 402 (FIG. 4) to generate the obstacle map 502. In one embodiment, the obstacle map 502 includes mapped objects 506 corresponding to the physical objects 504 located in the enclosed environment 404. In example 500, the obstacle map 502 include mapped objects 506 located on the floor (e.g., sofa, dining table with chairs) of the enclosed environment 404. In one embodiment, the obstacle map 502 may also include mapped objects 506 located in the air space (e.g., lanterns hanging from the ceiling) of the enclosed environment 404. For simplicity, mapped objects 506 are illustrated as boxes in the obstacle map. However, in at least one embodiment, mapped objects 506 may include the original shapes corresponding to the objects 504 located in the enclosed environment 404.

According to one embodiment, the second set of measurements M2 from the distance measuring sensors 406 may include real-time measurements that may capture any movements of the objects 504 in the enclosed environment 206 (e.g., moving robots in a warehouse). In one embodiment, the sensor data 228 may include a real-time stream of data that may be continuously or periodically transmitted from the distance measuring sensors 406 to the indoor navigation program 150. In one embodiment, the indoor navigation program 150 may use the real-time second set of measurements M2 to dynamically update the obstacle map 502. Thus, the obstacle map 502 may include a dynamic map that captures any movements of the mapped objects 506 corresponding to movements of the objects 504 in the enclosed environment 206. In one embodiment, the indoor navigation program 150 may generate and store a visualization of the obstacle map 502 which may be accessed and viewed by the user on a display device.

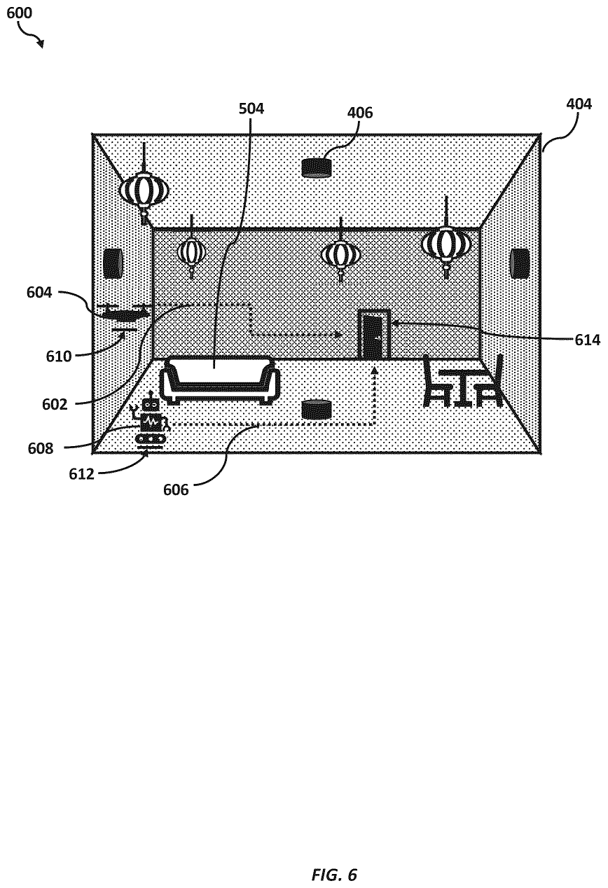

Referring now to FIG. 6, a schematic block diagram illustrating an example 600 of generating a movement path using the indoor navigation program 150 according to at least one embodiment is depicted. FIG. 6 provides a description of example 600 with reference to the indoor navigation system 200 (FIG. 2), example 400 of generating the baseline map 402 (FIG. 4), and example 500 of generating the obstacle map 502 (FIG. 5).

According to one embodiment, the indoor navigation program 150 may generate a first movement path 602 for a first navigation device 604 that is trying to move through or explore the enclosed environment 404. The indoor navigation program 150 may also generate (e.g., simultaneously) a second movement path 606 for a second navigation device 608 that is trying to move through or explore the enclosed environment 404. In one embodiment, the indoor navigation program may tailor the movement path 602, 606 for each navigation device 604, 608 based on one or more characteristics of the navigation device (e.g., size, shape, ground-based movement, aerial movement). For example, first movement path 602 may be an aerial movement path based on determining that the first navigation device 604 is an aerial device. Similarly, second movement path 606 may be a ground movement path based on determining that the second navigation device 608 is a ground-based device.

In one embodiment, the indoor navigation program 150 may receive the obstacle map 502 (FIG. 5) and apply a shortest path algorithm to create an obstacle free movement path 602, 606 for the navigation devices 604, 608 from respective first and second source locations 610, 612 (e.g., start point) to a destination location 614 (e.g., end point). In various examples, the source and destination locations for each navigation device 604, 608 may be different. In one embodiment, the distance measuring sensors 406 may be used to locate the navigation devices 604, 608 in a manner similar to the obstacle detection described in FIG. 5. As such, the respective first and second source locations 610, 612 of the navigation devices 604, 608 may be determined by locating the navigation devices 604, 608 using the distance measuring sensors 406.

The movement paths 602, 606 may be fed to the navigation devices 604, 608 to enable the navigation devices 604, 608 to move autonomously through the enclosed environment 404 without colliding with any objects 504 or other navigation devices 604, 608. In one embodiment, the movement paths 602, 606 may also be provided to the navigation devices 604, 608 to enable exploration of the enclosed environment 404, rather than moving from the source locations 610, 612 to the destination location 614. In one embodiment, the movement path may be updated by the indoor navigation program 150 in real-time, based on any changes in the obstacle map 502 (e.g., movement of objects 504 in the enclosed environment 404).

It is contemplated that the indoor navigation program 150 may provide several advantages and/or improvements to the technical field of indoor navigation. The indoor navigation program 150 may also improve the functionality of a computer because the indoor navigation program 150 may enable the computer to automate real-time object detection of dynamic obstacles for indoor navigation using fewer computing resources. The indoor navigation program 150 may also improve the functionality of a computer by centralizing the mapping of the enclosed environment using the distance measuring sensors and having to rely on mapping provided by each navigation device moving through the enclosed environment. The indoor navigation program 150 may also improve the functionality of a computer by centralizing the navigation guidance of multiple navigation devices moving through the enclosed environment. As such, the indoor navigation program 150 may not having to rely on onboard navigation sensors of each navigation device. The centralization of the mapping and navigation may also provide better coordination of the movements of multiple navigation devices in an enclosed environment.

It may be appreciated that FIGS. 2 to 6 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a set of sensor data from at least one distance measuring sensor located in an enclosed environment;
generating a baseline map of the enclosed environment based on the received set of sensor data;
detecting at least one object in the enclosed environment based on the received set of sensor data;
generating an obstacle map of the enclosed environment by plotting the detected at least one object in the generated baseline map of the enclosed environment; and
determining a movement path through the enclosed environment that avoids the detected at least one object in the generated obstacle map.

2. The computer-implemented method of claim 1, wherein the generated baseline map includes a plurality of boundaries that define the enclosed environment.

3. The computer-implemented method of claim 1, further comprising:
transmitting the determined movement path to a navigation device for traversing through the enclosed environment.

4. The computer-implemented method of claim 2, wherein the received set of sensor data includes a first set of measurements indicating a first respective distance between the at least one distance measuring sensor and the plurality of boundaries that define the enclosed environment.

5. The computer-implemented method of claim 4, wherein the received set of sensor data includes a second set of measurements indicating a second respective distance between the at least one distance measuring sensor and the detected at least one object in the enclosed environment.

6. The computer-implemented method of claim 5, further comprising:
comparing the first set of measurements associated with the plurality of boundaries and the second set of measurements associated with the detected at least one object to determine an exact position of the detected at least one object in the generated obstacle map of the enclosed environment.

7. The computer-implemented method of claim 1, further comprising:
receiving a real-time update in the received set of sensor data, wherein the received real-time update in the received set of sensor data indicates a movement of the detected at least one object in the enclosed environment; and
dynamically updating the generated obstacle map of the enclosed environment to indicate the movement of the detected at least one object.

8. The computer-implemented method of claim 3, further comprising:
determining a specification of the navigation device traversing through the enclosed environment; and
tailoring the determined movement path for the navigation device based on the determined specification of the navigation device.

9. The computer-implemented method of claim 1, further comprising:
detecting a plurality of navigation devices in the enclosed environment; and
transmitting the determined movement path to each navigation device of the detected plurality of navigation devices for traversing through the enclosed environment, wherein the transmitted movement path is tailored for each navigation device.

10. A computer system for dynamic indoor navigation, the computer system comprising:
one or more processors, one or more computer-readable memories and one or more computer-readable storage media;
program instructions, stored on at least one of the one or more storage media for execution by at least one of the one or more processors via at least one of the one or more memories, to receive a set of sensor data from at least one distance measuring sensor located in an enclosed environment;
program instructions, stored on at least one of the one or more storage media for execution by at least one of the one or more processors via at least one of the one or more memories, to generate a baseline map of the enclosed environment based on the received set of sensor data;
program instructions, stored on at least one of the one or more storage media for execution by at least one of the one or more processors via at least one of the one or more memories, to detect at least one object in the enclosed environment based on the received set of sensor data;
program instructions, stored on at least one of the one or more storage media for execution by at least one of the one or more processors via at least one of the one or more memories, to generate an obstacle map of the enclosed environment by plotting the detected at least one object in the generated baseline map of the enclosed environment; and
program instructions, stored on at least one of the one or more storage media for execution by at least one of the one or more processors via at least one of the one or more memories, to determine a movement path through the enclosed environment that avoids the detected at least one object in the generated obstacle map.

11. The computer system of claim 10, wherein the generated baseline map includes a plurality of boundaries that define the enclosed environment.

12. The computer system of claim 10, further comprising:
program instructions, stored on at least one of the one or more storage media for execution by at least one of the one or more processors via at least one of the one or more memories, to transmit the determined movement path to a navigation device for traversing through the enclosed environment.

13. The computer system of claim 11, wherein the received set of sensor data includes a first set of measurements indicating a first respective distance between the at least one distance measuring sensor and the plurality of boundaries that define the enclosed environment.

14. The computer system of claim 13, wherein the received set of sensor data includes a second set of measurements indicating a second respective distance between the at least one distance measuring sensor and the detected at least one object in the enclosed environment.

15. The computer system of claim 14, further comprising:
program instructions, stored on at least one of the one or more storage media for execution by at least one of the one or more processors via at least one of the one or more memories, to compare the first set of measurements associated with the plurality of boundaries and the second set of measurements associated with the detected at least one object to determine an exact position of the detected at least one object in the generated obstacle map of the enclosed environment.

16. The computer system of claim 10, further comprising:
program instructions, stored on at least one of the one or more storage media for execution by at least one of the one or more processors via at least one of the one or more memories, to receive a real-time update in the received set of sensor data, wherein the received real-time update in the received set of sensor data indicates a movement of the detected at least one object in the enclosed environment; and
program instructions, stored on at least one of the one or more storage media for execution by at least one of the one or more processors via at least one of the one or more memories, to dynamically update the generated obstacle map of the enclosed environment to indicate the movement of the detected at least one object.

17. The computer system of claim 12, further comprising:
program instructions, stored on at least one of the one or more storage media for execution by at least one of the one or more processors via at least one of the one or more memories, to determine a specification of the navigation device traversing through the enclosed environment; and
program instructions, stored on at least one of the one or more storage media for execution by at least one of the one or more processors via at least one of the one or more memories, to tailor the determined movement path for the navigation device based on the determined specification of the navigation device.

18. The computer system of claim 10, further comprising:
program instructions, stored on at least one of the one or more storage media for execution by at least one of the one or more processors via at least one of the one or more memories, to detect a plurality of navigation devices in the enclosed environment; and
program instructions, stored on at least one of the one or more storage media for execution by at least one of the one or more processors via at least one of the one or more memories, to transmit the determined movement path to each navigation device of the detected plurality of navigation devices for traversing through the enclosed environment, wherein the transmitted movement path is tailored for each navigation device.

19. A computer program product for dynamic indoor navigation, the computer program product comprising:
one or more computer-readable storage media;
program instructions, stored on at least one of the one or more storage media, to receive a set of sensor data from at least one distance measuring sensor located in an enclosed environment;
program instructions, stored on at least one of the one or more storage media, to generate a baseline map of the enclosed environment based on the received set of sensor data;
program instructions, stored on at least one of the one or more storage media, to detect at least one object in the enclosed environment based on the received set of sensor data;
program instructions, stored on at least one of the one or more storage media, to generate an obstacle map of the enclosed environment by plotting the detected at least one object in the generated baseline map of the enclosed environment; and
program instructions, stored on at least one of the one or more storage media, to determine a movement path through the enclosed environment that avoids the detected at least one object in the generated obstacle map.

20. The computer program product of claim 19, wherein the generated baseline map includes a plurality of boundaries that define the enclosed environment.
